(19) United States
(12) Patent Application Publication
(10) Pub. No.: US 2024/0308164 A1
(43) Pub. Date: Sep. 19, 2024

(54) CUTTING DEVICE AND METHOD FOR CUTTING A TIRE COMPONENT

(71) Applicant: VMI HOLLAND B.V., Epe (NL)

(72) Inventors: Peter SCHIPPER, Epe (NL); Gerardus Johannes Catharina VAN LAAR, Epe (NL)

(21) Appl. No.: 18/566,292

(22) PCT Filed: May 16, 2022
(86) PCT No.: PCT/EP2022/063144

§ 371 Date: Dec. 1, 2023

(30) Foreign Application Priority Data
Jun. 1, 2021 (NL) 2028361

(51) Int. Cl. B29D 30/46; B26D 1/00; B26D 1/18

(52) U.S. Cl. CPC B29D 30/46; B26D 1/0006; B26D 1/18

(57) ABSTRACT

A cutting device and a method are provided for cutting a tire component. The cutting device includes a counter member and a cutting disc that is movable in a cutting direction over a cutting stroke along said counter member for cutting the tire component in cooperation with said counter member. The cutting disc, at an end of the cutting stroke, is movable in a lifting direction from a cutting position at the counter member into a standby position away from the counter member. The cutting disc, in said standby position, is movable in a return direction opposite to the cutting direction over a return stroke. The cutting device further includes a braking member that is fixed in the lifting direction at the standby position for braking the rotation of the cutting disc when said cutting disc is in the standby position.

### BACKGROUND

The invention relates to a cutting device and a method for cutting a tire component.

A known cutting device of the ‘disc-and-bar’ cutter type comprises a cutting disc that is movable in a cutting direction over a cutting stroke along a cutting bar for cutting a tire component in cooperation with said cutting bar. During the cutting stroke, the cutting disc rotates as a result of the relative movement between the cutting disc and the cutting bar and friction generated between the cutting disc and the cutting bar.

At the end of the cutting stroke, the cutting disc is raised into a standby position in which it no longer contacts the cutting bar. In said standby position, the cutting disc is moved over a return stroke in a return direction opposite to the cutting direction. At the end of the return stroke, the cutting disc can be lowered again for another cutting stroke.

### SUMMARY OF THE INVENTION

A disadvantage of the known cutting device is that the cutting disc is freely rotatable in the standby position and continues to rotate after the cutting stroke. In particular, the cutting disc does not slow down enough to fully stop rotating before reaching the end of the return stroke. When the cutting disc is lowered towards the cutting bar while still rotating, the cutting disc and/or the cutting bar may be damaged, thus decreasing the durability of the cutting device. Hence, the known cutting device has to wait until the cutting disc has completely stopped rotating until the cutting disc can be lowered again for the next cutting stroke. This significantly increases the cycle time of the cutting operation.

It is an object of the present invention to provide a cutting device and a method for cutting a tire component, wherein the cycle time of the cutting device can be improved.

According to a first aspect, the invention provides a cutting device for cutting a tire component, wherein the cutting device comprises a counter member extending along a cutting line and a cutting disc that is movable in a cutting direction over a cutting stroke along said cutting line while the cutting disc is rotatable about a disc axis for cutting the tire component in cooperation with said counter member, wherein the cutting disc, at an end of the cutting stroke, is movable in a lifting direction from a cutting position at the counter member into a standby position away from the counter member, wherein the cutting disc, in said standby position, is movable in a return direction opposite to the cutting direction over a return stroke, wherein the cutting device further comprises a braking member that is fixed in the lifting direction at the standby position for braking the rotation of the cutting disc when said cutting disc is in the standby position.

The braking member can effectively slow down any rotation of the cutting disc carried over from the cutting stroke into the return stroke. In particular, the cutting disc can be slowed down as soon as it is in the standby position. Preferably, the cutting disc has nearly or completely stopped rotating before or when said cutting disc reaches the end of the return stroke. Hence, the cutting disc can immediately be lowered into the cutting position again for the next cutting stroke, without risk of damage to the cutting disc and/or the counter member as a result of rotation of the cutting disc during said lowering. This can significantly reduce the cycle time of the cutting operation. By moving the cutting disc towards the braking member instead of moving the braking member towards the cutting disc, the braking member can remain in a stationary position. Hence, the braking member does not require any positioning means, such as drives, actuators or the like, thereby reducing the complexity of the cutting device.

In a preferred embodiment the lifting direction extends perpendicular to the cutting line and an axial direction parallel to the disc axis. Hence, the cutting disc can be moved in said lifting direction to a position above and spaced apart from the counter member.

In another embodiment the cutting device comprises a carriage for holding the cutting disc and a cutting guide for guiding the carriage along said cutting guide in the cutting direction, wherein the braking member is supported by the carriage to move together with the cutting disc in the cutting direction. Hence, the cutting disc can be slowed down as soon as it is in the standby position and can be slowed down further during at least a part of the return stroke. In particular, the cutting disc can be slowed down by the braking member continuously during the return stroke.

More preferably, the braking member is arranged in a fixed position on the carriage. With the braking member being mounted in a stationary position relative to the carriage, the braking member does not require any positioning means, such as drives, actuators or the like, thereby reducing the complexity of the cutting device. Less components also means less overall weight and/or less inertia of the carriage and the components carried thereon, thereby allowing for an even faster return of the cutting disc in the return direction.

Additionally or alternatively, the cutting disc is movable relative to the carriage in the lifting direction between the cutting position and the standby position. By moving the cutting disc towards the braking member instead of moving the braking member towards the cutting disc, the braking member can remain in a stationary position, with the same technical advantages as mentioned in relation to the previously discussed embodiment.

In a further embodiment the cutting disc is displaced in the lifting direction when moving from the cutting position into the standby position over at least twenty millimeters, and preferably over at least forty millimeters. This can be sufficient to move the cutting disc into the working range of the braking member, i.e. into its magnetic field, as discussed hereafter. Conversely, the cutting disc can effectively be moved out of the working range of the braking member when it is in the cutting position to prevent that the braking member hinders the rotation of the cutting disc when said cutting disc is in the cutting position.

In a further embodiment the cutting disc has a disc body that defines a circumferential edge, wherein the braking member is located opposite to the circumferential edge in an axial direction parallel to the disc axis when the cutting disc is in the standby position. Hence, the braking member can act on said circumferential edge in the axial direction to slow down the rotation of the cutting disc.

Preferably, the braking member comprises a braking body extending along a part of the circumferential edge when the cutting disc is in the standby position. The cutting disc can be slowed down by engaging this part of the circumference only, while the rest of the circumference can be kept free, for example for moving the cutting disc relative to the braking member into and out of the standby position.

More preferably, the braking body is arcuate with a radius matching the cutting disc. The braking body can therefore closely follow the curvature of the cutting disc.

Alternatively, the cutting disc has a disc body and a brake disc located in an axial direction parallel to the disc axis behind the disc body and rotationally fixed to said disc body, wherein the braking member is located opposite to the brake disc in a radial direction perpendicular to the disc axis when the cutting disc is in the standby position. In contrast to the previous embodiment, the cutting disc according to this alternative embodiment is not engaged directly by the braking member. Instead, the brake disc is engaged, which indirectly slows down the cutting disc. Hence, the cutting disc can be optimally designed for cutting, whereas the brake disc can be designed for optimal interaction with the braking member, i.e. by choosing a material for both functions, or by choosing a specific diameter, shape, surface treatment, or the like.

In another embodiment the braking member is configured for contactless braking of the rotation of the cutting disc. In other words, the cutting disc, in the standby position, is spaced apart from the braking member in an axial direction parallel to the disc axis over a spacing distance. In the previously discussed alternative embodiment, the brake disc, in the standby position of the cutting disc, is spaced apart from the braking member in the radial direction over a spacing distance. Contactless braking can reduce or eliminate wear between the braking member and the cutting disc.

In another embodiment the braking member comprises one or more magnets for magnetically braking the rotation of the cutting disc. The magnets, preferably permanent magnets, can create a magnetic field that can slow down the cutting disc with electromagnetic induction.

Preferably, the one or more magnets comprises a plurality of magnets distributed in an arcuate array with a radius matching the cutting disc. The plurality of magnets can thus be made to follow the contour or the circumferential edge of the cutting disc.

In particular, the braking member is an Eddy current brake. The Eddy current brake can effectively slow down the cutting disc by dissipating kinetic energy as heat.

In a further embodiment the counter member comprises a cutting bar. The cutting disc and the cutting bar can effectively cooperate for cutting the tire component along a cutting line defined by said cutting bar.

According to a second aspect, the invention provides a method for cutting a tire component using the cutting device according to any one of the embodiments of the first aspect of the invention, wherein the method comprises the steps of:
moving the cutting disc in the cutting direction over the cutting stroke along the cutting line while the cutting disc rotates about the disc axis for cutting the tire component in cooperation with the counter member;
moving the cutting disc in the lifting direction from the cutting position at the counter member into the standby position away from the counter member at the end of the cutting stroke;
moving the cutting disc in the return direction over the return stroke; and
braking the rotation of the cutting disc with the braking member when said cutting disc is in the standby position.

The method relates to the practical implementation of the cutting device according to the first aspect of the invention and thus has the same technical advantages, which will not be repeated hereafter.

Preferably, the braking member brakes the rotation of the cutting disc with contactless braking.

In a further embodiment the braking member brakes the rotation of the cutting disc by generating an Eddy current.

In a further embodiment the method further comprises the step of:
moving the cutting disc in a lowering direction opposite to the lifting direction at an end of the return stroke only when the cutting disc has stopped rotating as a result of the braking by the braking member.

The various aspects and features described and shown in the specification can be applied, individually, wherever possible. These individual aspects, in particular the aspects and features described in the attached dependent claims, can be made subject of divisional patent applications.

### BRIEF DESCRIPTION OF THE DRAWINGS

The invention will be elucidated on the basis of an exemplary embodiment shown in the attached schematic drawings, in which:

FIGS. 1 and 2 show front views of a cutting device for cutting a tire component according to a first exemplary embodiment of the invention at the start and the end of a cutting stroke, respectively;

FIGS. 3 and 4 show front views of the cutting device of FIGS. 1 and 2 at the start and the end of a return stroke, respectively;

FIG. 5 shows a cross section of the cutting device according to the line V-V in FIG. 1; and

FIG. 6 shows a cross section of an alternative cutting device according to a second exemplary embodiment of the invention.

### DETAILED DESCRIPTION OF THE INVENTION

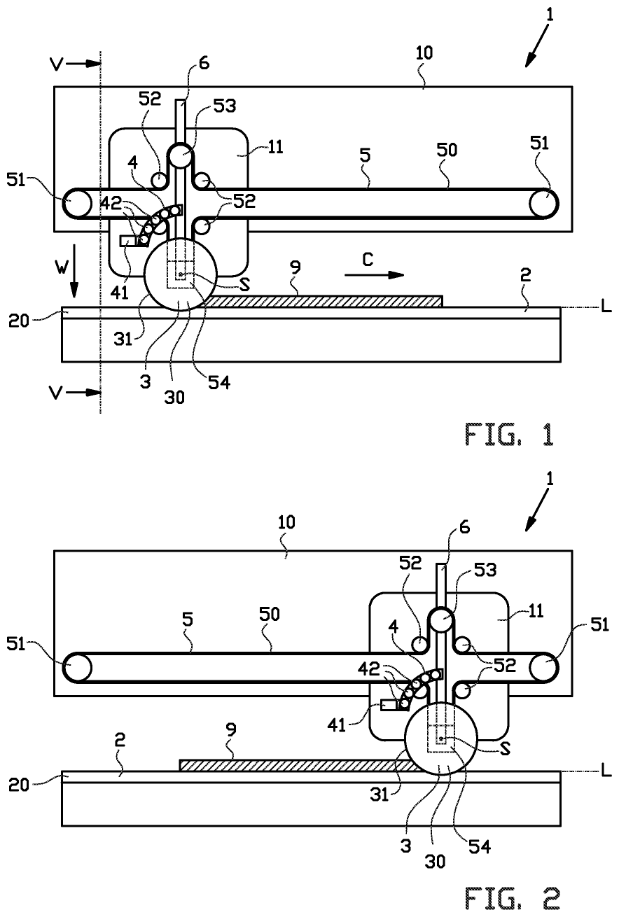

FIGS. 1-5 show a cutting device 1 according to a first exemplary embodiment of the invention for cutting a tire component 9. The cutting device 1 comprises a counter member 2 and a cutting disc 3 that cooperate to cut the tire component 9 along a cutting line L.

In this example, as shown in FIG. 1, the counter member 2 comprises a cutting bar 20 extending along a cutting line L. Alternatively, the counter member 2 may be a counter disc or another suitable element providing counter pressure for the cutting disc 3 during cutting.

The cutting device 1 comprises a cutting guide 10 and a carriage 11 that is movable in the cutting direction C along said cutting guide 10. The carriage 11 is configured or arranged for holding the cutting disc 3 relative to the counter member 2. The movement of the carriage 11 along the cutting guide 10 is driven by a linear drive (not shown) in a manner know per se. The carriage 11 is movable in the cutting direction C over a range that is sufficient to cut the tire component 9 across its entire width in a single cutting stroke.

As shown in FIGS. 1-4, the cutting disc 3 has a circular disc body 30 that defines or has a circumferential edge 31. The cutting disc 3 is freely rotatable about a disc axis S. The disc axis S defines an axial direction A. The disc axis S is concentric to said circumferential edge 31. The cutting disc 3 rotates when the carriage 11 is moved in the cutting direction C as a result of friction between the counter member 2 and the cutting disc 3.

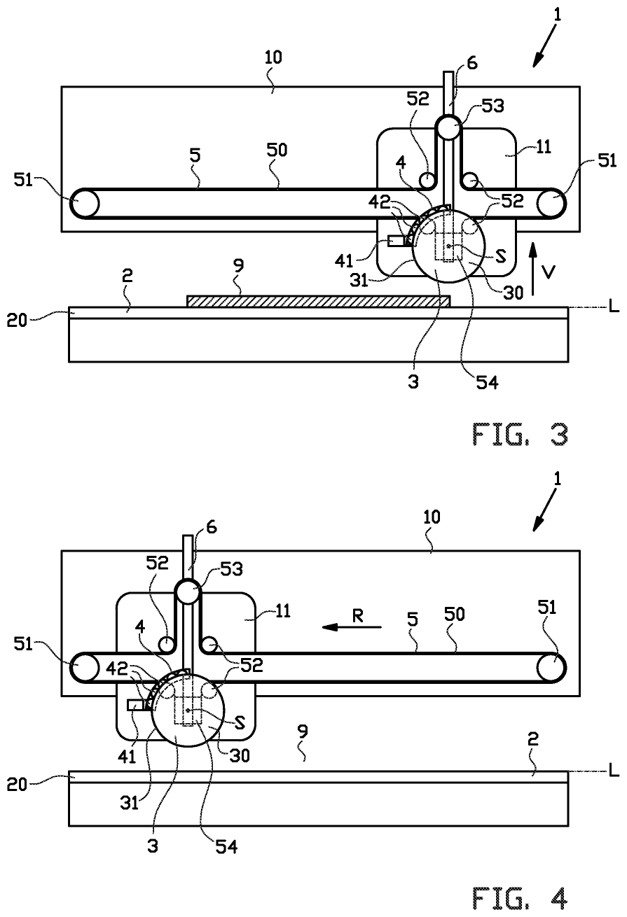

The cutting disc 3 is movable relative to the carriage 11 in a lifting direction V from a cutting position, as shown in FIGS. 1 and 2, into a standby position, as shown in FIGS. 3 and 4. In the cutting position, the cutting disc 3 is positioned at and/or overlaps with the counter member 2. In particular, the counter member 2 is actively pressed against the cutting disc 3 in the axial direction A to ensure proper cutting. In the standby position the cutting disc 3 is moved, lifted or raised away from the counter member 2. More in particular, the cutting disc 3 and the counter member 2 are no longer directly opposite to each other in the axial direction A when the cutting disc 3 is in the standby position. In other words, the cutting disc 3 is positioned clear off, spaced apart from and/or well above the counter member 2 in the lifting direction V when said cutting disc 3 is in the standby position. In this example, the lifting direction V is perpendicular to the cutting direction C and/or the axial direction A. In particular, the lifting direction V is vertical or substantially vertical.

The cutting device 1 is provided with a disc positioning drive 5 for moving the cutting disc 3 between the cutting position and the standby position. In this exemplary embodiment, the cutting disc 3 is movable by said disc positioning drive 5 in the lifting direction V relative to the carriage 11. In particular, the disc positioning drive 5 comprises a belt 50 and a number of pulleys 51, 52, 53 for guiding the belt 50. The belt 50 is connected with both ends to a holder 54 for the cutting disc 3. The holder 54 is connected to a position guide 6 that moves together with the holder 54, and thus together with the cutting disc 3, in the lifting direction V. In this example, the pulleys 51, 52, 53 comprise two drive pulleys 51 for pulling said belt 50 at different speeds, thereby effectively displacing the cutting disc 3 in the lifting direction V. The remaining pulleys 52, 53 are guide pulleys. One of the guide pulleys 53 is mounted on the position guide 6 to move together with the cutting disc 3 in the lifting direction V. The disc positioning drive 5 as shown can thus act in a way similar to a so-called ‘gantry drive’.

It will be appreciated that many variations to the disc position drive 5 can be envisioned that would yet be encompassed by the scope of the present invention. For example, the cutting disc 3 may be moved by an electric, pneumatic or hydraulic drive, a linkage, gears, or the like.

As shown by comparing FIGS. 2 and 3, the cutting disc 3 is moved in the lifting direction V at the end of the cutting stroke from the cutting position into the standby position as shown in FIG. 3. In said standby position, the cutting disc 3 is movable in a return direction R opposite to the cutting direction C over a return stroke. The cutting disc 3 is preferably moved over a return stroke equal to the cutting stroke, such that the cutting disc 3 can be returned to its original position relative to the cutting direction C prior to cutting. At the end of the return stroke, the cutting disc 3 is lowered in a lowering direction W, opposite to the lifting direction V, from the standby position into the cutting position, thereby providing the situation as shown in FIG. 1. The situation of FIG. 1 can be the start of a new cycle of the cutting operation.

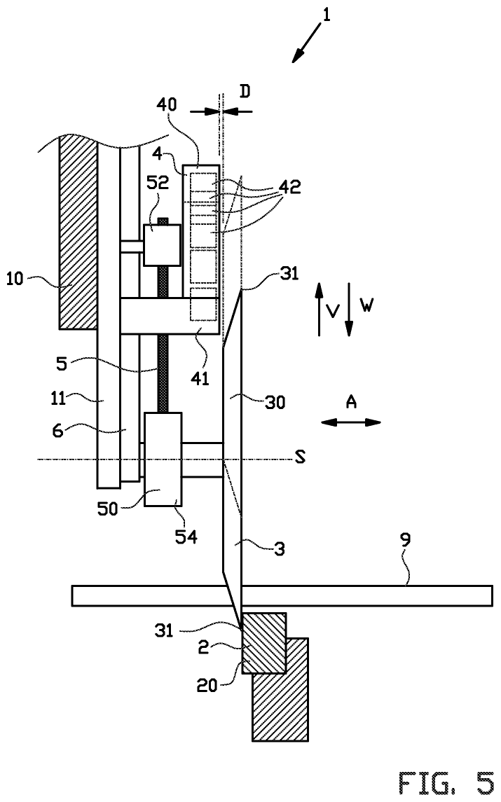

As best seen in FIGS. 1 and 5, the cutting device 1 further comprises a braking member 4 for braking the rotation of the cutting disc 3 when said cutting disc 3 is in the standby position. The braking member 4 is fixed in the lifting direction V at the standby position. In this example, the braking member 4 is supported by the carriage 11 to move together or synchronously with the cutting disc 3 in the cutting direction C. The braking member 4 is therefore fixed to or in a fixed position relative to the carriage 11. In this example, the braking member 4 comprises a braking body 40 and a brake holder 41 for holding the braking member 4 relative to the carriage 11. Preferably, the brake holder 41 is configured for directly, rigidly and/or fixedly connecting the braking member 4 to said carriage 11.

In an alternative embodiment (not shown), the braking member 4 may be positioned in a braking position that is not only fixed in the lifting direction V, but in the cutting direction C as well. Such a braking member 4 may for example be fitted to the cutting guide 10 in a way that does not interfere with the movement of the carriage 11.

As shown in FIG. 5, the braking member 4 is positioned such that it is located at least partially opposite to the circumferential edge 31 in the axial direction A when the cutting disc 3 is in the standby position.

As shown in FIG. 1, the braking body 40 is arcuate. The arc-shaped braking body 40 preferably has a radius substantially equal to or matching the radius of the cutting disc 3. In this example, the braking body 40 extends along or opposite to a part of the circumferential edge 31 when the cutting disc 3 is in the standby position. The braking member 4 is configured for contactless braking of the rotation of the cutting disc 3. In particular, the cutting disc 3, in the standby position, is spaced apart from the braking member 4 in an axial direction A parallel to the disc axis S over a spacing distance D. The spacing distance D is greater than zero. More in particular, the spacing distance D is greater than one millimeter, but less than five millimeters.

In this embodiment, the braking member 4 comprises a plurality of magnets 42, preferably permanent magnets, for magnetically braking the rotation of the cutting disc 3, i.e. by generating electromagnetic induction, also known as ‘Eddy current’. Preferably, the magnets 42 together generate a magnetic field that is sufficiently strong to slow down the rotation of the cutting disc 3 during the time it takes to complete the return stroke. The magnets 42 are distributed in an arcuate array with a radius substantially equal to or matching the radius of the cutting disc 3. Each magnet 42 is facing towards and/or is directly opposite to the cutting disc 3 at or near the circumferential edge 31 thereof.

Preferably, the cutting disc 3 is displaced in the lifting direction V when moving from the cutting position into the standby position, or vice versa in the lowering direction W, over at least twenty millimeters, and preferably over at least forty millimeters. Such a movement range is considered sufficient to move the cutting disc 3 to within the working range of the braking member 4 in the standby position, and out of the working range of the braking member 4 in the cutting position.

A method for cutting the tire component 9 using the aforementioned cutting device 1 will now be briefly elucidated with reference to FIGS. 1-4.

FIGS. 1 and 2 show the situations prior to and after the step of moving the cutting disc 3 in the cutting direction C over the cutting stroke along the counter member 2 and/or the cutting line L while the cutting disc 3 rotates about the disc axis S for cutting the tire component 9 in cooperation with the counter member 2.

FIGS. 2 and 3 show the situations prior to and after the step of moving the cutting disc 3 in the lifting direction V from the cutting position at the counter member 2 into the standby position away from the counter member 2 at the end of the cutting stroke.

FIGS. 3 and 4 shows the situations prior to and after the step of moving the cutting disc 3 in the return direction R over the return stroke. During this step, the cutting disc 3 is moved within the working range of the braking member 4, thus resulting in the braking member 4 slowing down the rotation of the cutting disc 3. The slowing down starts as soon as the cutting disc 3 moves into the standby position and continues during at least a part of the return stroke. When the cutting disc 3 has already stopped rotating prior to reaching the end of the return stroke, the braking member 4 will ensure that the cutting disc 3 remains stationary.

FIGS. 4 and 1 show the situations prior to and after the step of moving the cutting disc 3 in a lowering direction W opposite to the lifting direction V at the end of the return stroke. This step is performed only when the cutting disc 3 has completely stopped rotating as a result of the braking by the braking member 4, to prevent damage to the cutting disc 3 and/or the counter member 2.

It is to be understood that the above description is included to illustrate the operation of the preferred embodiments and is not meant to limit the scope of the invention. From the above discussion, many variations will be apparent to one skilled in the art that would yet be encompassed by the scope of the present invention.

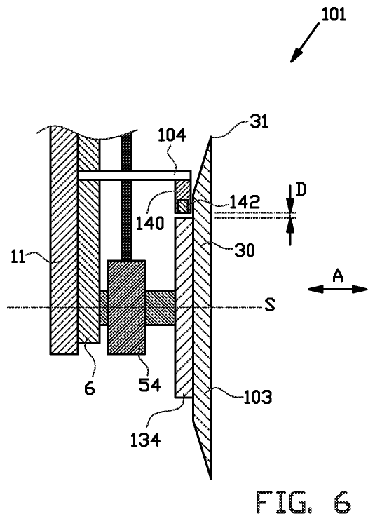

For example, FIG. 6 shows an alternative cutting device 101 according to a second exemplary embodiment of the invention, which differs from the aforementioned cutting device 1 in that its cutting disc 103 is provided with a brake disc 134 positioned in the axial direction A behind or alongside the disc body 30. The brake disc 134 is rotationally fixed to the disc body 130, i.e. so as to rotate together or in unison. The alternative cutting device 101 further differs in that its braking member 104 has a braking body 140 that is spaced apart from the brake disc 134 in a radial direction perpendicular to the disc axis S over the aforementioned spacing distance D. In particular, the braking member 104 is located opposite to the brake disc 134 in in said radial direction when the cutting disc 103 is in the standby position.

Furthermore, as shown in FIG. 6, the one or more magnets 142 are positioned at a side of the braking body 140 facing towards the brake disc 134 in the radial direction.

In summary, the invention relates to a cutting device 1 and method for cutting a tire component 9, wherein the cutting device 1 comprises a counter member 2 and a cutting disc 3 that is movable in a cutting direction C over a cutting stroke along said counter member 2 for cutting the tire component 9 in cooperation with said counter member 2, wherein the cutting disc 3, at an end of the cutting stroke, is movable in a lifting direction V from a cutting position at the counter member 2 into a standby position away from the counter member 2, wherein the cutting disc 3, in said standby position, is movable in a return direction R opposite to the cutting direction C over a return stroke, wherein the cutting device 1 further comprises a braking member 4 that is fixed in the lifting direction V at the standby position for braking the rotation of the cutting disc 3 when said cutting disc 3 is in the standby position.

1-21. (canceled)

22. A cutting device for cutting a tire component, the cutting device comprising:
a counter member extending along a cutting line; and
a cutting disc that is movable in a cutting direction over a cutting stroke along said cutting line while the cutting disc is rotatable about a disc axis for cutting the tire component in cooperation with said counter member,
wherein the cutting disc, at an end of the cutting stroke, is movable in a lifting direction from a cutting position at the counter member into a standby position away from the counter member,
wherein the cutting disc, in said standby position, is movable in a return direction opposite to the cutting direction over a return stroke,
wherein the cutting device further comprises a braking member that is fixed in the lifting direction at the standby position for braking the rotation of the cutting disc when said cutting disc is in the standby position.

23. The cutting device according to claim 22, wherein the lifting direction extends perpendicular to the cutting line and an axial direction parallel to the disc axis.

24. The cutting device according to claim 22, wherein the cutting device comprises a carriage for holding the cutting disc and a cutting guide for guiding the carriage along said cutting guide in the cutting direction,
wherein the braking member is supported by the carriage to move together with the cutting disc in the cutting direction.

25. The cutting device according to claim 24, wherein the braking member is arranged in a fixed position on the carriage.

26. The cutting device according to claim 24, wherein the cutting disc is movable relative to the carriage in the lifting direction between the cutting position and the standby position.

27. The cutting device according to claim 22, wherein the cutting disc is displaced in the lifting direction when moving from the cutting position into the standby position over at least twenty millimeters.

28. The cutting device according to claim 22, wherein the cutting disc has a disc body that defines a circumferential edge,
wherein the braking member is located opposite to the circumferential edge in an axial direction parallel to the disc axis when the cutting disc is in the standby position.

29. The cutting device according to claim 28, wherein the braking member comprises a braking body extending along a part of the circumferential edge when the cutting disc is in the standby position.

30. The cutting device according to claim 29, wherein the braking body is arcuate with a radius matching the cutting disc.

31. The cutting device according to claim 22, wherein the cutting disc has a disc body and a brake disc located in an axial direction parallel to the disc axis behind the disc body and rotationally fixed to said disc body,
wherein the braking member is located opposite to the brake disc in an radial direction perpendicular to the disc axis when the cutting disc is in the standby position.

32. The cutting device according to claim 22, wherein the braking member is configured for contactless braking of the rotation of the cutting disc.

33. The cutting device according to claim 22, wherein the cutting disc, in the standby position, is spaced apart from the braking member in an axial direction parallel to the disc axis over a spacing distance.

34. The cutting device according to claim 31, wherein the brake disc, in the standby position of the cutting disc, is spaced apart from the braking member in the radial direction over a spacing distance.

35. The cutting device according to claim 22, wherein the braking member comprises one or more magnets for magnetically braking the rotation of the cutting disc.

36. The cutting device according to claim 35, wherein the one or more magnets comprises a plurality of magnets distributed in an arcuate array with a radius matching the cutting disc.

37. The cutting device according to claim 22, wherein the braking member is an Eddy current brake.

38. The cutting device according to claim 22, wherein the counter member comprises a cutting bar.

39. A method for cutting a tire component using the cutting device according to claim 22, the method comprising the steps of:
moving the cutting disc in the cutting direction over the cutting stroke along the cutting line while the cutting disc rotates about the disc axis for cutting the tire component in cooperation with the counter member;
moving the cutting disc in the lifting direction from the cutting position at the counter member into the standby position away from the counter member at the end of the cutting stroke;
moving the cutting disc in the return direction over the return stroke; and
braking the rotation of the cutting disc with the braking member when said cutting disc is in the standby position.

40. The method according to claim 39, wherein the braking member brakes the rotation of the cutting disc with contactless braking.

41. The method according to claim 39, wherein the braking member brakes the rotation of the cutting disc by generating an Eddy current.

42. The method according to claim 39, wherein the method further comprises the step of:
moving the cutting disc in a lowering direction opposite to the lifting direction at an end of the return stroke only when the cutting disc has stopped rotating as a result of the braking by the braking member.
